(19) United States
(12) Patent Application Publication
(10) Pub. No.: US 2017/0206618 A1
(43) Pub. Date: Jul. 20, 2017

(54) ENTERTAINMENT INDUSTRY EDUCATION ADMINISTRATION SYSTEM AND METHODS

(71) Applicant: Brian Kraft, Los Angeles, CA (US)

(72) Inventor: Brian Kraft, Los Angeles, CA (US)

(21) Appl. No.: 15/406,582

(22) Filed: Jan. 13, 2017

Related U.S. Application Data
(60) Provisional application No. 62/278,916, filed on Jan. 14, 2016.

(51) Int. Cl. G06Q 50/20; G09B 19/00; G09B 5/12; G06Q 10/10; G09B 5/02

(52) U.S. Cl. CPC G06Q 50/2053; G06Q 10/10; G09B 5/02; G09B 5/12; G09B 19/00

(57) ABSTRACT

Provided herein are systems and methods for facilitating administration of entertainment industry education. The system includes at least one set of executable instructions stored in a non-transitory computer-readable medium for enabling a non-generic processor to facilitate the administration of the entertainment industry education by way of a user-interface, the user-interface configured to provide access to at least one education program module. The at least one education program module is selected from a film industry education program module, a radio industry education program module, a recording industry education program module, a television industry education program module, a theater industry education program module, and a concert industry education program module.

### CROSS-REFERENCE TO RELATED APPLICATION

This application claims priority to U.S. Provisional Patent Application No. 62/278,916, filed Jan. 14, 2016, titled “Entertainment Industry Education Administration System,” the disclosure of which is hereby incorporated herein by reference in its entirety.

### FIELD OF INVENTION

The present disclosure technically relates to entertainment industry systems and methods. More particularly, the present disclosure technically relates to entertainment industry education systems and methods. Even more particularly, the present disclosure technically relates to entertainment industry education systems and methods for facilitating administration.

### BACKGROUND

In the related art, online education has become a popular form of learning, e.g., for individuals who are remotely located from a particular learning institution, such as universities, colleges, and trade schools. Such individuals might desire a self-paced program or might have a physical disability that would limit travel to a learning institution's physical location. In one application of Internet-based training (or digital learning), course materials are presented simultaneously to groups of students in virtual classrooms. A virtual instructor typically develops a curriculum and presents the course, wherein students participate and conduct threaded discussions among one another in an interactive manner. Testing can be conducted online; and assessments and feedback can also be provided online. However, related art online education is not well-equipped to handle admissions and matriculation properly.

As such, a long-felt need exists for an education system that facilitates, not only, handling the curriculum, but that also fully handles administration of the educational endeavor, including admissions and matriculation.

### SUMMARY

In addressing many of the problems experienced in the related art, the present disclosure involves an entertainment industry education system and methods for facilitating administration, including admissions and matriculation.

In accordance with an embodiment of the present disclosure, a system for facilitating administration of entertainment industry education, includes: at least one set of executable instructions stored in a non-transitory computer-readable medium for enabling a non-generic processor to facilitate administration of entertainment industry education by way of a user-interface, the user-interface configured to provide access to at least one education program module, and the at least one education program module selected from a film industry education program module, a radio industry education program module, a recording industry education program module, a television industry education program module, a theater industry education program module, and a concert industry education program module.

In accordance with another embodiment of the present disclosure, a method of providing a system for facilitating administration of entertainment industry education, includes: storing at least one set of executable instructions in a non-transitory computer-readable medium for enabling a non-generic processor to facilitate administration of entertainment industry education by way of a user-interface; configuring the user-interface to provide access to at least one education program module; and providing the at least one education program module selected from a film industry education program module, a radio industry education program module, a recording industry education program module, a television industry education program module, a theater industry education program module, and a concert industry education program module.

In accordance with yet another embodiment of the present disclosure, a method of facilitating administration of entertainment industry education, includes: providing a system for facilitating administration of entertainment industry education, the system including at least one set of executable instructions in a non-transitory computer-readable medium for enabling a non-generic processor to facilitate administration of entertainment industry education by way of a user-interface; configuring the user-interface to provide access to at least one education program module; providing the at least one education program module, the at least one education program module selected from a film industry education program module, a radio industry education program module, a recording industry education program module, a television industry education program module, a theater industry education program module, and a concert industry education program module; providing online access to the system; and applying for at least one entertainment educational program via the online access.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a flow diagram illustrating operation of a system for facilitating administration of entertainment industry education in accordance with some embodiments.

FIG. 2 is a flow diagram illustrating a method of providing a system for facilitating administration of entertainment industry education in accordance with some embodiments.

FIG. 3 is a flow diagram illustrating a method of facilitating administration of entertainment industry education by way of system in accordance with some embodiments.

FIG. 4 is a schematic illustrating components of one or more server or client computing systems in accordance with some embodiments.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. Also, common, but well-understood, elements that are useful or necessary in a commercially feasible embodiment are often not depicted in order to facilitate a less obstructed view of these various embodiments of the present disclosure.

### DETAILED DESCRIPTION

The following description is not to be taken in a limiting sense, but is made merely for the purpose of describing the general principles of exemplary embodiments. The scope of the disclosure should be determined with reference to the claims. Reference throughout this specification to “one embodiment,” “an embodiment,” or similar language means that a particular feature, structure, or characteristic that is described in connection with the referenced embodiment is included in at least the referenced embodiment. Likewise, reference throughout this specification to “some embodiments” or similar language means that particular features, structures, or characteristics that are described in connection with the referenced embodiments are included in at least the referenced embodiments. Thus, appearances of the phrases “in one embodiment,” “in an embodiment,” “in some embodiments,” and similar language throughout this specification can, but do not necessarily, all refer to the same embodiment.

Further, the described features, structures, or characteristics of the present disclosure can be combined in any suitable manner in one or more embodiments. In the description, numerous specific details are provided for a thorough understanding of embodiments of the disclosure. One skilled in the relevant art will recognize, however, that the embodiments of the present disclosure can be practiced without one or more of the specific details, or with other methods, components, materials, and so forth. In other instances, well-known structures, materials, or operations are not shown or described in detail to avoid obscuring aspects of the present disclosure.

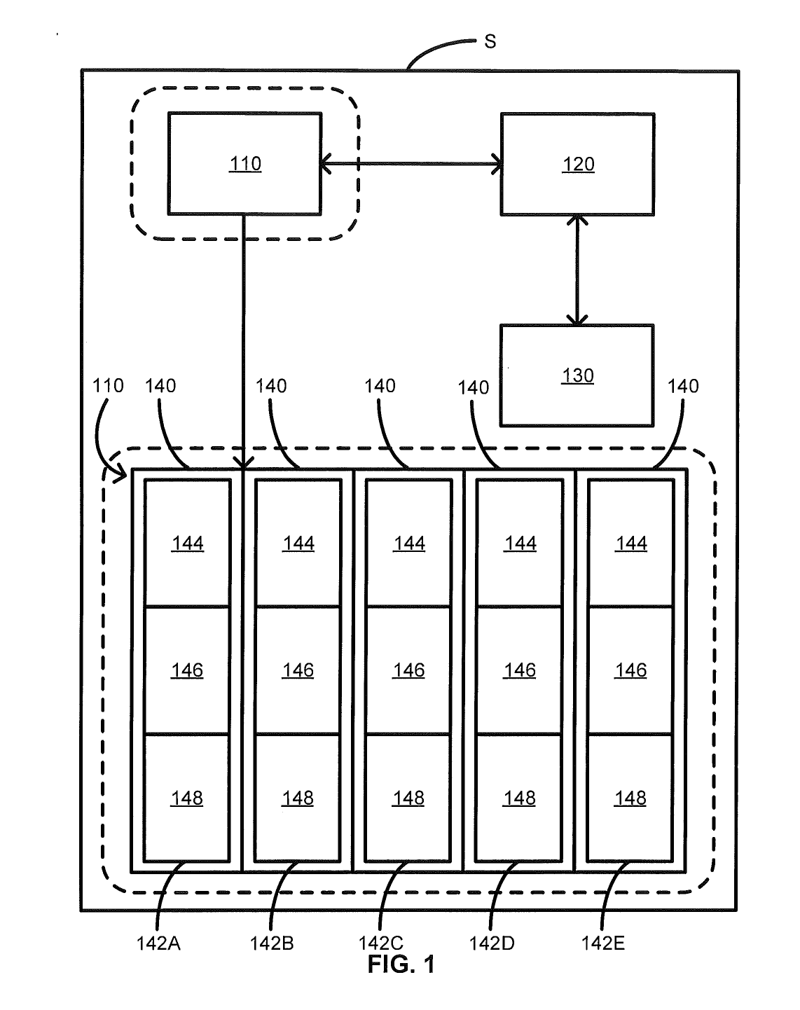

Referring to FIG. 1, this flow diagram illustrates an operational sequence of a system S for facilitating administration of entertainment industry education, in accordance with an embodiment of the present disclosure. The system S includes: at least one set of executable instructions stored in a non-transitory computer-readable medium 110 for enabling a non-generic processor 120 to facilitate administration of entertainment industry education by way of a user-interface 130, the user-interface 130 configured to provide access to at least one education program module 140, and the at least one education program module 140 including at least one of a film industry education program module 142A, a radio industry education program module 142B, a recording industry education program module 142C, a television industry education program module 142D, a theater industry education program module 142E, and a concert industry education program module 142F (not shown). Each education program module of the education program modules 142A, 142B, 142C, 142D, 142E, and 142F includes at least one of an admission program sub-module 144, a mentor program sub-module 146, and an administrator program sub-module 148.

Still referring to FIG. 1, the admission program sub-module 144 is configured to facilitate an online application process for at least one student applicant, and provide at least one automated telephone voice response to receiving a completed online application, the at least one automated telephone voice response observing at least one of etiquette and protocol, receive at least one voice-activated message from the at least one student applicant; and provide at least one automated telephone voice response to the at least one voice-activated message from the at least one student applicant.

An admission program sub-module 144 for one education program module 140 can have the foregoing, more general features (e.g., facilitate an online application process, provide an automated telephone voice response, etc.) in common with any one or more of the other admission program sub-modules. An admission program sub-module 144 for one education program module 140 can also have different, more specific features from any one or more of the other admission program sub-modules. For example, the film industry education program module 142A can have a specific admission program sub-module 144A (not shown) to facilitate an online film industry application process, the radio industry education program module 142B can have a specific admission program sub-module 144B (not shown) to facilitate a radio industry application process, the recording industry education program module 142C can have a specific admission program sub-module 144C (not shown) to facilitate an online recording industry application process, and so on. Indeed, the admission program sub-module 144 can be industry specific in any one or more of the foregoing, more general features providing different, more specific features (e.g., facilitate an online, industry-specific application process, provide an automated, industry-specific telephone voice response, etc.).

Still referring to FIG. 1, the mentor program sub-module 146 is configured to facilitate at least one contact by at least one member of an admission office, and facilitate at least one contact by at least one mentor. The at least one contact by at least one member of an admission office involves executing a script relating to at least one topic of an academic interview; a solicitation of student applicant expectations and characteristics; a statement relating to advantages to an online education; information relating to a curriculum; a disclosure relating to at least one of audition, apprenticeship, and internship; job placement; networking opportunity; a complimentary tutoring service; at least one testimonial; accreditation information; tuition and payment information; and strategic study information.

A mentor program sub-module 146 for one education program module 140 can have the foregoing, more general features (e.g., facilitate contact by a mentor, facilitate executing a script, etc.) in common with any one or more of the other mentor program sub-modules. A mentor program sub-module 146 for one education program module 140 can also have different, more specific features than any one or more of the other mentor program sub-modules. For example, the film industry education program module 142A can have a specific mentor program sub-module 146A (not shown) to facilitate executing an interview script relating to at least one film industry topic, the radio industry education program module 142B can have a specific mentor program sub-module 146B (not shown) to facilitate executing an interview script relating to at least one radio industry topic, the recording industry education program module 142C can have a specific mentor program sub-module 146C (not shown) to facilitate executing an interview script relating to at least one recording industry topic. Indeed, the mentor program sub-module 146 can be industry specific in any one or more of the foregoing, more general features providing different, more specific features (e.g., facilitate contact by at least one industry-specific mentor, facilitate executing an industry-specific script, etc.).

Still referring to FIG. 1, the at least one contact by the at least one member of an admission office involves executing a script relating to at least one topic of querying wellness of the student applicant; a solicitation of further questions that the student applicant might have; confirming the student applicant's understanding of available educational programs; information relating to a one-to-one educating ratio; querying the student applicant for at least one goal; information relating to technologies available for a given entertainment industry; job placement information; querying a referral source; querying source of funding; and in-person interview information.

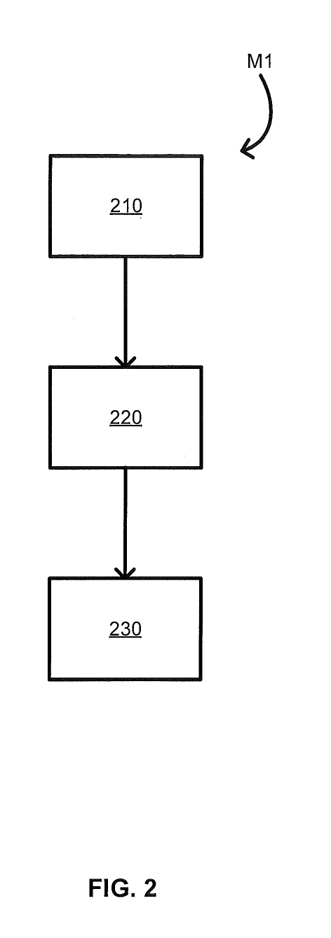

Referring to FIG. 2, this flow diagram illustrates a method M1 of providing a system S for facilitating administration of entertainment industry education, in accordance with an embodiment of the present disclosure. The method M1 includes: storing at least one set of executable instructions in a non-transitory computer-readable medium for enabling a non-generic processor to facilitate administration of entertainment industry education by way of a user-interface, as indicated by block 210; configuring the user-interface to provide access to at least one education program module, as indicated by block 220; and providing the at least one education program module, the at least one education program module selected from a film industry education program module, a radio industry education program module, a recording industry education program module, a television industry education program module, a theater industry education program module, and a concert industry education program module, as indicated by block 230.

Still referring to FIG. 2, in the method M1, providing the at least one education program module, as indicated by block 230, includes providing the at least one education program module with at least one of an admission program sub-module, a mentor program sub-module, or an administrator program sub-module. Also, in the method M1, providing the admission program sub-module includes configuring the admission program sub-module to facilitate an online application process for at least one student applicant; provide at least one automated telephone voice response to receiving a completed online application observing at least one of etiquette and protocol; receive at least one voice-activated message from the at least one student applicant; and provide at least one automated telephone voice response to the at least one voice-activated message from the at least one student applicant. Further, in the method M1, providing the admission program sub-module includes configuring the admission program sub-module to facilitate at least one contact by at least one member of an admission office, and facilitate at least one contact by at least one mentor.

Still referring to FIG. 2, in the method M1, configuring the admission program sub-module includes configuring the admission program sub-module to facilitate the at least one contact by the at least one member of an admission office in executing a script relating to at least one topic of an academic interview; a solicitation of the student applicant's expectations and characteristics; a statement relating to advantages of an online education; information relating to a curriculum; a disclosure relating to at least one of an audition, an apprenticeship, and an internship; job placement; networking opportunities; a complimentary tutoring service; at least one testimonial; accreditation information; tuition and payment information; and strategic study information.

Still referring to FIG. 2, in the method M1, configuring the admission program sub-module includes configuring the admission program sub-module to facilitate the at least one contact by the at least one member of an admission office in executing a script relating to at least one topic of querying wellness of the student applicant; a solicitation of further questions that the student applicant might have; confirming the student applicant's understanding of available educational programs; information relating to a one-to-one educating ratio; querying the student applicant for at least one goal; information relating to technologies available for a given entertainment industry; job placement information; querying a referral source; querying source of funding; and in-person interview information.

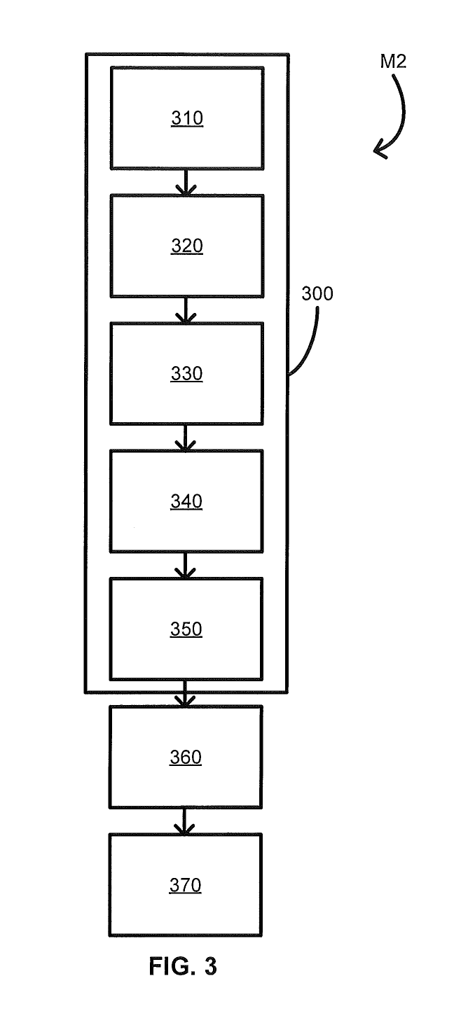

Referring to FIG. 3, this flow diagram illustrates a method M2 of facilitating administration of entertainment industry education by way of system, in accordance with an embodiment of the present disclosure. The method M2 includes providing a system for facilitating administration of entertainment industry education, as indicated by block 300, the system configured for storing at least one set of executable instructions in a non-transitory computer-readable medium for enabling a non-generic processor to facilitate administration of entertainment industry education by way of a user-interface, as indicated by block 310; providing the user-interface for access to at least one education program module, as indicated by block 320; and providing the at least one education program module selected from a film industry education program module, a radio industry education program module, a recording industry education program module, a television industry education program module, a theater industry education program module, and a concert industry education program module, as indicated by block 330; providing online access to the system, as indicated by block 340; and applying for at least one entertainment educational program via the online access, as indicated by block 350. The method M2 further includes participating in the at least one entertainment educational program via the online access, as indicated by block 360; and matriculating from the at least one entertainment educational program via the online access, as indicated by block 370.

### Computing Systems

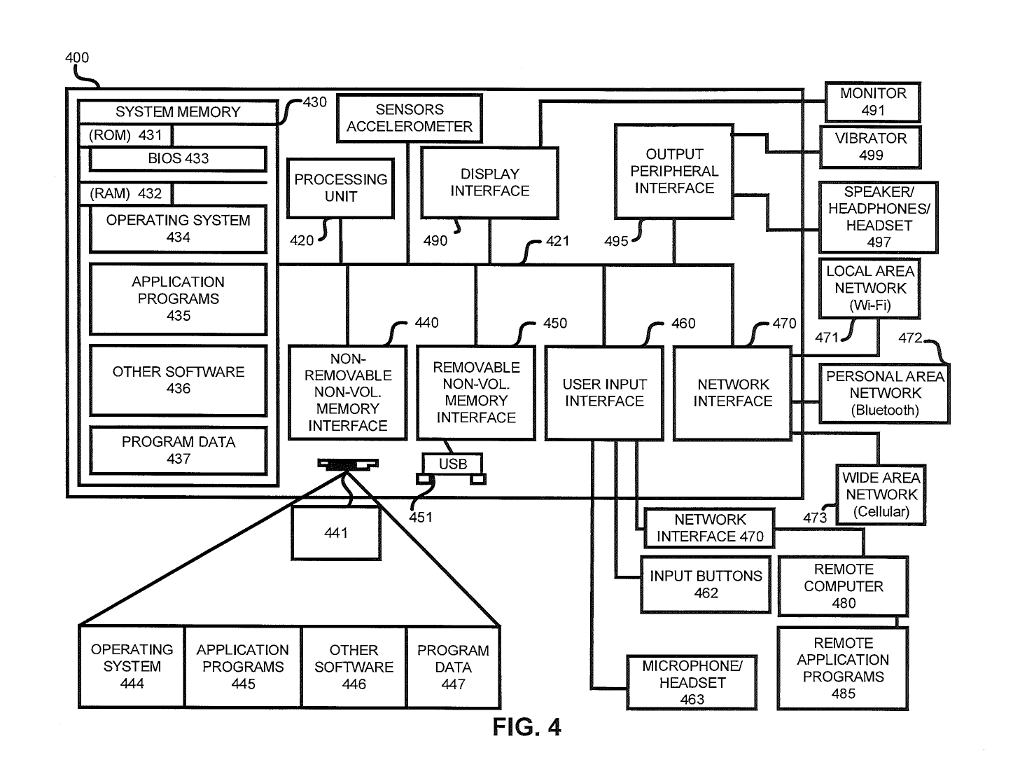

FIG. 4 is a schematic illustrating one or more components of a computing system 400 such as a server or client computing system in accordance with some embodiments. One or more servers, clients, or a combination thereof of the entertainment industry systems provided herein can be partially represented by the one or more components of the computing system 400 or wholly represented by all the components of the computing system 400.

Referring to FIG. 4, components of the computing system 400 can include, but are not limited to, a processing unit 420 having one or more processing cores, a system memory 430, and a system bus 421 that couples various system components including the system memory 430 to the processing unit 420. The system bus 421 can be any of several types of bus structures selected from a memory bus or memory controller, a peripheral bus, and a local bus using any of a variety of bus architectures.

The computing system 400 can include computing machine-readable media. The computing machine-readable media can be any available media that can be accessed by the computing system 400 and includes both volatile and non-volatile media, and removable and non-removable media. By way of example, and not limitation, computing machine-readable media use includes storage of information, such as computer-readable instructions, data structures, other executable software or other data. The computing machine-readable media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible medium that can be used to store the desired information and that can be accessed by the computing device 400. Transitory media such as wireless channels are not included in the computing machine-readable media. Communication media typically embody computer-readable instructions, data structures, other executable software, or other transport mechanisms and include any information delivery media. As an example, some client computing systems on a network might not have optical or magnetic storage.

The system memory 430 can include computing machine-readable media in the form of volatile and/or non-volatile memory such as read-only memory (ROM) 431 and random access memory (RAM) 432. A basic input/output system 433 (BIOS) containing basic routines configured for transferring information between elements within the computing system 400, such as during start-up, can be stored in the ROM 431. The RAM 432 can contain data and/or software immediately accessible to and/or presently being operated on by the processing unit 420. By way of example, and not limitation, FIG. 4 illustrates that the RAM 432 can include a portion of the operating system 434, the application programs 435, other executable software 436, and the program data 437.

The computing system 400 can also include other removable/non-removable volatile/nonvolatile computing machine-readable media. By way of example only, FIG. 4 illustrates a solid-state memory 441. Other removable/non-removable, volatile/nonvolatile computing machine-readable media that can be used in the example operating environment include, but are not limited to, USB drives and devices, flash memory cards, solid-state RAM, solid-state ROM, and the like. The solid-state memory 441 can be connected to the system bus 421 through a non-removable memory interface such as interface 440, and the USB drive 451 can be connected to the system bus 421 by a removable memory interface, such as interface 450.

The drives and their associated computing machine-readable media discussed above and illustrated in FIG. 4 provide storage of computer-readable instructions, data structures, other executable software and other data for the computing system 400. In FIG. 4, for example, the solid-state memory 441 is illustrated for storing operating system 444, application programs 445, other executable software 446, and program data 447. Note that these components can either be the same as or different from the operating system 434, the application programs 435, the other executable software 436, and the program data 437. The operating system 444, the application programs 445, the other executable software 446, and the program data 447 are given different numbers here to illustrate that, at a minimum, they can be different copies.

A user (e.g., an administrator, a mentor, a student applicant, etc.) can enter commands and information into the computing system 400 through input devices such as a keyboard, a touchscreen, software or hardware input buttons 462, a microphone 463, or a pointing device or scrolling input component such as a mouse, trackball, or touch pad. The microphone 463 can cooperate with speech recognition software. These and other input devices can be connected to the processing unit 420 through a user interface 460 that is coupled to the system bus 421, but these and other input devices can also be connected by other interface and bus structures such as a parallel port, game port, or USB. A display monitor 491 or other type of display screen device can be connected to the system bus 421 via an interface, such as a display interface 490. In addition to the monitor 491, the computing system 400 can also include other peripheral output devices such as speakers 497, a vibrator 499, and other output devices, which can be connected through an output peripheral interface 495.

The computing system 400 can operate in a networked environment using logical connections to one or more remote computers/client devices, such as a remote computing system 480. The remote computing system 480 can be a server, a personal computer, a hand-held device, a router, a peer device or other common network node, and can include many or all of the elements described above relative to the computing system 400. The logical connections depicted in FIG. 4 can include a personal area network (“PAN”) 472 (e.g., Bluetooth®), a local area network (“LAN”) 471 (e.g., Wi-Fi), and a wide area network (“WAN”) 473 (e.g., cellular network), but the logical connections can also include other networks. Such networking environments can be found in offices, enterprise-wide computer networks, intranets and the Internet. A browser application can be resident on the computing device and stored in the memory.

When used in a LAN networking environment, the computing system 400 can be connected to the LAN 471 through a network interface or adapter 470, which can be, for example, a Wi-Fi adapter. When used in a WAN networking environment (e.g., Internet), the computing system 400 typically includes some means for establishing communications over the WAN 473 such as the network interface 470. With respect to mobile telecommunication technologies, for example, a radio interface, which can be internal or external, can be connected to the system bus 421 via the network interface 470, or some other appropriate mechanism. In a networked environment, other software depicted relative to the computing system 400, or portions thereof, can be stored in a remote memory storage device. By way of example, and not limitation, FIG. 4 illustrates remote application programs 485 as residing on remote computing device 480. It will be appreciated that the network connections shown are examples and other means of establishing a communications link between the computing devices can be used.

In some embodiments, software used to facilitate algorithms discussed herein can be embodied onto a non-transitory machine-readable medium. A machine-readable medium includes any mechanism that stores information in a form readable by a machine (e.g., a computer). For example, a non-transitory machine-readable medium can include read only memory (ROM); random access memory (RAM); magnetic disk storage media; optical storage media; flash memory devices; Digital Versatile Disc (DVD's), EPROMs, EEPROMs, FLASH memory, magnetic or optical cards, or any type of media suitable for storing electronic instructions.

Note, an application described herein includes but is not limited to software applications, mobile apps, and programs that are part of an operating system application. Some portions of this disclosure are presented in terms of algorithms and symbolic representations of operations on data bits within a computer memory. These algorithmic descriptions and representations are the means used by those skilled in the data-processing arts to most effectively convey the substance of their work to others skilled in the art. An algorithm is conceived to be a self-consistent sequence of steps leading to a desired result. The steps are those requiring physical manipulations of physical quantities. These quantities can take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. These algorithms can be written in a number of different software programming languages such as C, C+, or other similar languages. Also, an algorithm can be implemented with lines of code in software, configured logic gates in software, or a combination of both. In an embodiment, the logic consists of electronic circuits that follow the rules of Boolean logic, software that contain patterns of instructions, or any combination of both.

It should be borne in mind, however, that all of these and similar terms associated with the appropriate physical quantities are merely convenient labels applied to these quantities. Unless specifically stated otherwise or apparent from the above discussions, it is appreciated that throughout the disclosure terms such as “processing,” “computing,” “calculating,” “determining,” “displaying,” or the like, refer to the action and processes of a computer system (or similar electronic computing system) that manipulates and transforms data represented as physical (electronic) quantities within the computer system's registers and memories into other data similarly represented as physical quantities within the computer system memories or registers, or other such information storage, transmission, or display devices.

Many functions performed by electronic hardware components can be duplicated by software emulation. Thus, a software program written to accomplish those same functions can emulate the functionality of the hardware components in input-output circuitry.

### Examples

### Example 1: Example Script Facilitated by Mentor Program Sub-Module for Film Industry

As provided herein, the mentor program sub-module can be configured to facilitate at least one contact by at least one member of an admission office. The at least one contact by the at least one member of an admission office can involve executing a script such as the following example script, titled “Admission film program phone etiquette & protocols,” facilitated by the mentor program sub-module for the film industry:

### Admission Film Program Phone Etiquette & Protocols

[Make sure you're checking in and having them acknowledge what you're saying (45 second rule).]
1) Hello this is [YOUR NAME] calling from The Film Connection. You applied with us today. We're the only school that puts you in a real film company. How are you today?
   a) [NAME OF STUDENT APPLICANT], what are your needs when it comes to your film education? What are your goals?
      [Stop talking, listen to the student applicant, and connect with him/her. As the applicant is telling you his needs and concerns, validate and write them down.]
2) Do you know how we are different from other schools, [NAME OF STUDENT APPLICANT]?
   a) We're not placing you in a classroom environment. You're not learning alongside 10 to 20 other students. We're going to put you with a real world film maker in his/her film production company. We're placing you with someone who is working, someone who is paying their bills through filmmaking, NOT someone who is paying their bills solely on teaching like the other schools.
      You tell me “[NAME OF STUDENT APPLICANT] which would you rather learn from? Someone who has awards and real films under their belt? Or someone who has a certificate and is just teaching film?
      Upon completion of the course, you will be a certified graduate of the Film Connection, and that certification is a signal to the industry that you have 6 months or more of real film company experience in a real film company.
   b) Next, let's talk about how you are educated with our unique apprenticeship program:
      The Film Connection Film Program is broken into three phases all happening simultaneously.
      Phase I: Learn where you live. We will place you inside a real production company with a real filmmaker where you live!
      You will learn directing, cinematography, editing, lighting, how to be an AD, Pre-Production, Casting, Story boarding, budgeting and producing.
      The most important thing: You will learn how to have employable skills on the technical aspects of filmmaking.
      How do we do this? We place you one on one with a working professional filmmaker in your city!
      You'll be working and training in a real production company.
      Now, [NAME OF STUDENT APPLICANT], do you understand how this is much better for your film career than learning in a classroom?
      By learning one-on-one inside a real film production company you get hundreds of hours of on the job experience that cannot be duplicated in a classroom. So, while all the other film students around the world are learning in film schools, you will be gaining hands-on learning experience in your city!
      That was Phase I, [NAME OF STUDENT APPLICANT]. Is what I've said so far resonating with you?
      [Listen.]
      Well, we don't stop there.
      As Phase I is happening, we will take you through Phase II. Now, I want to be clear, Phase I and II happen at the same time. While you are working with your local film mentor, we will pair you with a well-known LA-based or New York-based writer or producer.
      This writer or producer works with you on one on one sessions, helping you to develop your best idea into a movie.
      Do you have an idea for a movie “[NAME OF STUDENT APPLICANT]? Something you've always had burning in your head? To tell a story about your life or about the world?
      Do you have an action movie or a comedy that you're dying to write and develop into a movie?
      [Stop talking and listen to the student applicant. As the applicant is telling you his idea, write it down.]
      Well, that's great because one of our private film mentors will work with you and help you develop [STUDENT APPLICANT'S MOVIE IDEA].
      So imagine [NAME OF STUDENT APPLICANT], in PHASE II, you're working in private sessions with one of these Hollywood Filmmakers: Sandy Stern, Producer of Being John Malkovich; Velvet Goldmine; or Paul Guay, writer of Liar Liar.
      Or you might be working with Judy Levine, Academy Award winning Producer of The Sessions. Imagine working one-on-one on [STUDENT APPLICANT'S MOVIE IDEA] with Ron Osborne, Producer of Meet Joe Black; Evan Astrowsky, who produced the horror film Cabin Fever; or John Raffia, who write The Relic.
      Let me get specific [NAME OF STUDENT APPLICANT] on how this works. The goal is to take your movie idea and—based on our expertise—pair you with one of the aforementioned Hollywood writers or Producers.
      Let's recap, [NAME OF STUDENT APPLICANT], as you're doing Phase I as an apprentice with a real filmmaker inside a film production company, you're also working with a second mentor who is helping you create [STUDENT APPLICANT'S MOVIE IDEA].
      Is what I'm saying connecting with you so far?
      Well, if that wasn't exciting enough for you, the Film Connection goes one step further. At the end of your education experience eight months later, you will either fly out to LA or NY and meet with a powerful Hollywood executive. You will pitch [STUDENT APPLICANT'S MOVIE IDEA] to that powerful Hollywood executive.
      We are the only film school on the planet that guarantees that every student will pitch their movie in the hope of getting it sold to Hollywood. Could you imagine pitching that over to someone like Grant Heslov? Grant is George Clooney's Producing Partner and Producer of Argo and Monument's Men, Or could you imagine flying to New York City and pitching your film idea to Film Nation? The company that made Act of Valor, Blue Jasmine, and The Kings Speech?
      Or could you imagine pitching your Reality TV Show idea [if the student applicant has one] to Alex Checking? Alex Checking worked on Project Green Light with Matt Damon and Ben Affleck.
      Or could you imagine coming to LA and pitching [STUDENT APPLICANT'S MOVIE IDEA] to the producer of Cabin Fever?
      You see, [NAME OF STUDENT APPLICANT], we are the only film school that has the connections and the relationships in the film world to help you connect to Hollywood with your idea.
      Let me recap, what you get with us is a one on one learning experience directing and editing as you are learning from a famous Hollywood film executive who can help you sell your idea to Hollywood.
      Now, [NAME OF STUDENT APPLICANT], at the top of this conversation you told me that you had the following [STUDENT APPLICANT'S NEEDS AND CONCERNS]. Do you see how this unique program is the best way meet those needs?
c) Also note, we are endorsed by Filmmakers David Lynch, Oliver Stone, Joel Schumacher, Grant Heslov, Sandy Stern, and Judy Levine. No other film school is endorsed by these professionals because these professionals agree that our program is the most cost effective way to become a film director, screenwriter, or film producer. We're also endorsed by radio mogul Larry King, who understands that you don't need a college education to be a filmmaker. Dr. Drew and Judge Mathis have also endorsed our program.
   [Describe film success stores from web site.]
3) Have you looked over our Job Assistance Program?
   a) We are the only school proactively helping our graduates find actual work in the industry. We have a 72% job placement rate because we're the only school that helps our students audition for a job from day one.
      Imagine, [NAME OF STUDENT APPLICANT], you're sitting at a film production company waiting to be interviewed by a professional filmmaker. You've graduated from our school, you have six months of experience under your belt, and sitting next to you is a graduate from a traditional school with zero experience. Which person do you think is going to get the job? You? The one with six months of experience? Or your neighbor, with no experience?
      We have three lines of defense for your career once you graduate that our Career Counseling Team takes very seriously. Britney Tobin, one of our Career Advisors says that
         i) We will contact your mentor and ask if they have a job for you and if they will hire you. If yes and yes, we get you hired!
         ii) If your mentor can't hire you, we reach out to who he/she knows, and we contact them to see if they will hire you.
         iii) If your mentor can't hire you, and if your mentor's contacts can't hire you, then we dig into our database of contacts to help you find work.
      Our Career Counseling Team takes this very seriously. We help you with your resume, cover letter, and portfolio. We bring your body of work to the forefront of social media by making websites and promoting your work and services online.
      Britney Tobin, one of our Career Advisors says that we encourage networking and believing that your career is a lifelong process. We go the extra mile when it comes to assisting our students in finding jobs after graduation through mentor recommendations and other great opportunities for collaboration.
      Do you understand, [NAME OF STUDENT APPLICANT], how this is the best option for your film career?
4) Do you understand that we do not accept everyone?
   a) We have to make certain that you're serious because this is a real place of business that we're sending you to. We're looking for people who can't imagine doing anything else with their lives. So, when you meet your mentor for the exclusive one-on-one interview, it will be up to him/her to accept you into the program.
      So please, let me be clear, [NAME OF STUDENT APPLICANT], you have to be accepted by the mentor to gain entry into our school.
      Also note that our institution is recognized by the Better Business Bureau with a grade of A.
5) Have you looked over the tuition costs?
   a) There are three ways to fund your tuition:
      i) Our tuition is $10,800, but, if you pay your tuition in full, we'll take off $1000 and you'll only have to pay $9800. Our goal is to help solve the student debt crisis, and we strongly encourage you to pay in full. You could save anywhere from $2-3K in interest charges and fees.
      ii) We also have financing for one to four years with a $2700 down payment, which means your payments could be as low as $200 per month.
      iii) Tuition Options loan, an off-shoot of Sallie Mae, is also an option. It is a government-backed credit-based loan program in which you would apply with a currently employed co-signer having a credit score of 680 or above. Although, once again, paying in full is your best bet.
6) If accepted, is this financially feasible for you at this time?
7) What is your availability to do this?
   a) Let me ask you “[NAME OF STUDENT APPLICANT], which of your family or friends is helping you with the tuition?
      [Request and write down information such as e-mail, phone number, etc. on parents, friends, guardians, or other helpers.]
      How do you intend to pay?
8) [Move to head of admissions? If yes:]
   a) You'll be receiving a call from the Head of Admissions, either David Kruk or Matt Johnson within 24 to 48 hours.
      [Stress the importance of being available for the call. Many students lose their opportunity to even get an interview for not returning the Head of Admission's call in a timely fashion.]
      Now, [NAME OF STUDENT APPLICANT], this is very important, especially since you told me that [STUDENT APPLICANT'S HELPER(S)] is helping you with your tuition. Many parents want to make sure that our school is legitimate, and we, of course, being the only school to place you in a real professional company, certainly understand that. I'm going to send you some emails with our success stories and our tuition options. It is essential that you show these emails to [STUDENT APPLICANT'S HELPER(S)]; it's very important.
      [Verify address and contact information for student applicant, as well that for the student applicant's helper(s)—especially because the address and contact information might be different.]
      Thank you for your interest in The Film Connection, and congratulations on taking the first step for an exciting professional film career. It's been a pleasure talking to you [NAME OF STUDENT APPLICANT]. Have a great day!”
9) [Move to head of admissions? If no:]
   a) When do you think you'll be ready to do a program like this?
      [Take notes and set a callback. Indicate the student applicant will receive two emails, and let them know they need to check their email. Verify their email address and phone number.]

Information as herein shown and described in detail is fully capable of attaining the above-described object of the present disclosure, the presently preferred embodiment of the present disclosure, and is, thus, representative of the subject matter that is broadly contemplated by the present disclosure. The scope of the present disclosure fully encompasses other embodiments that might become obvious to those skilled in the art, and is to be limited, accordingly, by nothing other than the appended claims. Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, work-piece, and fabrication material detail can be made, without departing from the spirit and scope of the present disclosure, as set forth in the appended claims, as might be apparent to those of ordinary skill in the art, are also encompassed by the present disclosure.

What is claimed:

1. A system for facilitating administration of entertainment industry education, comprising:
at least one set of executable instructions stored in a non-transitory computer-readable medium for enabling a non-generic processor to facilitate the administration of the entertainment industry education by way of a user-interface;
wherein the user-interface is configured to provide access to one or more education program modules; and
wherein each of the one or more education program modules is selected from a film industry education program module, a radio industry education program module, a recording industry education program module, a television industry education program module, a theater industry education program module, and a concert industry education program module.

2. The system of claim 1, wherein each of the one or more education program modules comprises:
at least one program sub-module selected from an admission program sub-module, a mentor program sub-module, and an administrator program sub-module.

3. The system of claim 2, wherein the admission program sub-module is configured to:
facilitate an online application process for at least one student applicant;
provide at least a first automated telephone voice response to receiving a completed online application, the first automated telephone voice response observing at least one of etiquette or protocol;
receive at least one voice-activated message from the at least one student applicant; and
provide at least a second automated telephone voice response to the at least one voice-activated message from the at least one student applicant.

4. The system of claim 2, wherein the mentor program sub-module is configured to:
facilitate at least one contact by at least one member of an admission office; and
facilitate at least one contact by at least one mentor.

5. The system of claim 4, wherein the at least one contact by the at least one member of an admission office comprises executing a script relating to at least one topic of an academic interview; a solicitation of student applicant expectations and characteristics; a statement relating to advantages of an online education; information relating to a curriculum; a disclosure relating to an audition, an apprenticeship, an internship, or a combination thereof; job placement; networking opportunities; a complimentary tutoring service; at least one testimonial; accreditation information; tuition and payment information; and strategic study information.

6. The system of claim 4, wherein at least one contact by at least one member of an admission office comprises executing:
a script relating to at least one topic of querying wellness of the student applicant; a solicitation of further questions that the student applicant might have; confirming the student applicant's understanding of available educational programs; information relating to a one-to-one educating ratio; querying the student applicant for at least one goal; information relating to technologies available for a given entertainment industry; job placement information; querying a referral source; querying source of funding; and in-person interview information.

7. A method of providing a system for facilitating administration of entertainment industry education, comprising:
storing at least one set of executable instructions in a non-transitory computer-readable medium for enabling a non-generic processor to facilitate the administration of the entertainment industry education by way of a user-interface;
configuring the user-interface to provide access to one or more education program modules; and
providing the one or more education program modules selected from a film industry education program module, a radio industry education program module, a recording industry education program module, a television industry education program module, a theater industry education program module, and a concert industry education program module.

8. The method of claim 7, wherein providing the one or more education program modules comprises providing each education program module with at least one program sub-module selected from an admission program sub-module, a mentor program sub-module, and an administrator program sub-module.

9. The method of claim 8, wherein providing each of the one or more education program modules with the admission program sub-module comprises configuring the admission program sub-module to:
facilitate an online application process for at least one student applicant;
provide at least a first automated telephone voice response to receiving a completed online application, the first automated telephone voice response observing at least one of etiquette or protocol;
receive at least one voice-activated message from the at least one student applicant; and
provide at least a second automated telephone voice response to the at least one voice-activated message from the at least one student applicant.

10. The method of claim 8, wherein providing each of the one or more education program modules with the admission program sub-module comprises configuring the admission program sub-module to:
facilitate at least one contact by at least one member of an admission office; and
facilitate at least one contact by at least one mentor.

11. The method of claim 10, wherein configuring the admission program sub-module comprises configuring the admission program sub-module to facilitate the at least one contact by the at least one member of an admission office in executing a script relating to at least one topic of an academic interview; a solicitation of the student applicant's expectations and characteristics; a statement relating to advantages of an online education; information relating to a curriculum; a disclosure relating to an audition, an apprenticeship, an internship, or a combination thereof; job placement; networking opportunities; a complimentary tutoring service; at least one testimonial; accreditation information; tuition and payment information; and strategic study information.

12. The method of claim 10, wherein configuring the admission program sub-module comprises configuring the admission program sub-module to facilitate the at least one contact by the at least one member of an admission office in executing a script relating to at least one topic of querying wellness of the student applicant; a solicitation of further questions that the student applicant might have; confirming the student applicant's understanding of available educational programs; information relating to a one-to-one educating ratio; querying the student applicant for at least one goal; information relating to technologies available for a given entertainment industry; job placement information; querying a referral source; querying source of funding; and in-person interview information.

13. A method of facilitating administration of entertainment industry education, comprising:
providing a system for facilitating administration of entertainment industry education, the system providing configured for:
storing at least one set of executable instructions in a non-transitory computer-readable medium for enabling a non-generic processor to facilitate the administration of the entertainment industry education by way of a user-interface;
providing the user-interface for access to one or more education program modules;
providing the one or more education program modules selected from a film industry education program module, a radio industry education program module, a recording industry education program module, a television industry education program module, a theater industry education program module, and a concert industry education program module;
providing online access to the system; and
enabling a student applicant to apply for at least one entertainment educational program via the online access.

15. The method of claim 13, further comprising:
matriculating the student applicant in the at least one entertainment educational program via the online access.

14. The method of claim 15, further comprising:
enabling the student applicant to participate in the at least one entertainment educational program via the online access.

16. The method of claim 15, wherein providing the one or more education program modules comprises providing each education program module with at least one program sub-module selected from an admission program sub-module, a mentor program sub-module, and an administrator program sub-module.

17. The method of claim 16, wherein providing each of the one or more education program modules with the admission program sub-module comprises configuring the admission program sub-module to:
facilitate enabling the student applicant to apply for the at least one entertainment educational program via the online access;
provide at least a first automated telephone voice response to receiving a completed online application, the first automated telephone voice response observing at least one of etiquette or protocol;
receive at least one voice-activated message from the student applicant; and
provide at least a second automated telephone voice response to the at least one voice-activated message from the student applicant.

18. The method of claim 16, wherein providing each of the one or more education program modules with the admission program sub-module comprises configuring the admission program sub-module to:
facilitate at least one contact by at least one member of an admission office; and
facilitate at least one contact by at least one mentor.

19. The method of claim 18, wherein configuring the admission program sub-module comprises configuring the admission program sub-module to facilitate the at least one contact by the at least one member of an admission office in executing a script relating to at least one topic of an academic interview; a solicitation of the student applicant's expectations and characteristics; a statement relating to advantages of an online education; information relating to a curriculum; a disclosure relating to an audition, an apprenticeship, an internship, or a combination thereof; job placement; networking opportunities; a complimentary tutoring service; at least one testimonial; accreditation information; tuition and payment information; and strategic study information.

20. The method of claim 18, wherein configuring the admission program sub-module comprises configuring the admission program sub-module to facilitate the at least one contact by the at least one member of an admission office in executing a script relating to at least one topic of querying wellness of the student applicant; a solicitation of further questions that the student applicant might have; confirming the student applicant's understanding of available educational programs; information relating to a one-to-one educating ratio; querying the student applicant for at least one goal; information relating to technologies available for a given entertainment industry; job placement information; querying a referral source; querying source of funding; and in-person interview information.
